(19) United States
(12) Patent Application Publication
(10) Pub. No.: US 2008/0139440 A1
(43) Pub. Date: Jun. 12, 2008

(54) VISUAL PERCEPTIBILITY OF IMAGES ON PRINTED FILM

(76) Inventors: Vincenzo Catalfamo, Cincinnati, OH (US); Frank William Denome, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/954,140

(22) Filed: Dec. 11, 2007

Related U.S. Application Data
(60) Provisional application No. 60/874,094, filed on Dec. 11, 2006.

(51) Int. Cl. C11D 17/04

(52) U.S. Cl. 510/296

(57) ABSTRACT

A method of improving the visual perceptibility of images on water-soluble printed films for unit dose detergent products through the use of coloured liquids located adjacent to the printed film and the unit dose detergent products having the printed film and coloured liquid.

### CROSS REFERENCE TO RELATED APPLICATION

This application claims benefit of and priority to U.S. Provisional Application Ser. No. 60/874,094, filed Dec. 11, 2006.

### FIELD OF THE INVENTION

The present invention is in the field of printed films, in particular it relates to the use of coloured liquids for improving the visual perceptibility of images on printed films when used in unit dose detergent products.

### BACKGROUND OF THE INVENTION

In the field of domestic laundry and dishwashing unit dose detergents have become a particularly well-liked alternative to traditional loose powder detergent products. They are particularly popular as they ensure uniform dosing, reduce spillage and ensure that the risk of detergent powder inhalation and/or ingestion is minimised. Overall, they provide a simple and effective means for dosing detergent, and it is this simplicity of use that makes them particularly popular with consumers. The first unit dose products to become widely used took the form of powder detergent tablets. They are formed by compressing or compacting detergent powders, in combination with binders and disintegrants, to form solid blocks. The tablets are individually wrapped in sealed water-impervious wrappers, which are often made from a foil/polymer-film laminate. This ensures that the tablets do not become exposed to water or humidity, and disintegrate as a result. The wrapper also prevents any loose powder from escaping if the tablets became chipped or damaged during transportation or storage. When used, a consumer removes and disposes the wrapper. The consumer then places the tablet in a machine dispenser compartment. Recently, however, there has been a trend towards using water-soluble or dispersible polymer films for containing unit doses of powdered detergents. The water-soluble or dispersible polymer films (hereinafter “water-soluble polymer films) remove the need for unwrapping the detergent prior to use, as the pouch will dissolve during the wash cycle. It also prevents the presence of loose powder and provides an overall more convenient execution for consumers.

The water soluble films used to form the pouches are predominantly made from clear, transparent water-soluble polymer films. By moving over to water-soluble polymer films, from the previously used polymer film laminates, printing upon the film has been found to be far harder to perceive visually. Without being bound by any particular theory this difficulty in visual perception is believed to be because of the granular nature of the detergent and the colour of the powder granules.

The present invention seeks to provide an improved unit dosed detergent product, which seeks addresses this and other problems.

### SUMMARY OF THE INVENTION

The present invention relates to a method of improving the visual perceptibility of images on water-soluble printed films comprising one or more images printed thereon for unit dose detergent products is a single or multi-compartment unit dose through the use of coloured liquids contained in the single or multi-compartment of the unit dose detergent product, the coloured liquids being located adjacent to the printed film. The present invention further relates to a unit dose detergent product comprising a one or more compartments comprising a water-soluble printed film comprising one or more images printed thereon, the one or more compartments containing a coloured liquid such that the one or more images have improved perceptibility.

### DETAILED DESCRIPTION OF THE INVENTION

The present invention encompasses the use of a compartment comprising a coloured liquid for improving the visual perceptibility of an image on a printed film. Preferably, wherein said printed film forms at least one of the outer walls of a single or multi compartment unit dose detergent product. Preferably, wherein said compartment comprising said coloured liquid further comprises said printed film. The benefit of using a coloured liquid for this purpose is that it typically provides an even and preferably light-permeable medium which improves the clarity of the image on the printed film compared to a noncoloured liquid or solid (such as a powdered detergent) being behind the printed film. Preferably, said coloured liquid is a detergent or contains at least one detergent active.

The present invention also encompasses the use of a compartment comprising the combination of a coloured liquid and a printed film for indicating the preferred orientation of a single- or multi-compartment unit dose product in an automatic dishwashing machine dispenser. Preferably, wherein said compartment comprising said coloured liquid further comprises said printed film. Preferably, wherein said printed film forms at least one of the outer walls of a multi-compartment unit dose detergent product. The benefit of using a coloured liquid for this purpose is that it has been found that the combination of a printed image and a coloured liquid on a particular side of unit dose product will direct the user to place unit dose product in a specific orientation. This means that cleaning adjuncts which are more sensitive to dispenser leakage or whose presence in the pre-rinse cycle is non-detrimental may be placed in the compartment comprising the coloured liquid. More sensitive cleaning components may then be placed in the optional compartment comprising the optional powder, where they will be less likely to be exposed to water should the dispenser leak. It also provides benefits in terms of the orientation in which the pouch lands in the base of the automatic dishwashing appliance once it has been released into the wash.

The present invention also encompasses a container comprising a plurality of individual multi-compartment unit dose products wherein the individual multi-compartment unit dose products comprise at least one compartment comprising a coloured liquid and a film having an image printed thereon. Preferably, wherein the plurality of multi-compartment pouches comprise different coloured liquids or different printed images to one another or combinations thereof. Preferably, said container comprises at least a portion through which its contents are visible. Preferably, at least a portion of the container is transparent.

In a preferred embodiment of the present invention the unit-dosed product is a dual compartment pouch. Preferably, a dual-compartment pouch wherein said compartments comprise a common wall or border, most preferably a common wall. Preferably, said multi-compartment pouch comprises at least one compartment comprising a liquid detergent and at least one compartment comprising a detergent powder.

In a further preferred embodiment of the present invention the unit dose product further comprises a compartment comprising a powder detergent. In a further embodiment of the present invention the powder detergent comprises one or more detergent adjuncts selected from the group consisting of builders, chelants, enzymes, bleaches, metal corrosion inhibitors, surfactants, glass corrosion inhibitors, soil release polymers and anti-scalants and combinations thereof. In a further preferred embodiment of the present invention the image on the printed film is situated on the side of the film in contact with the coloured liquid and/or the side of the film in contact with the surrounding atmosphere.

In a further preferred embodiment of the present invention the coloured liquid comprises a colourant, preferably a dye or a pigment, and at least one detergent adjunct selected from the group consisting of builders, chelants, enzymes, bleaches, metal protectors, surfactants, glass protectors, organic solvents and anti-scalants and combinations thereof. In a further preferred embodiment of the present invention the powder detergent and the printed image are substantially the same in colour. Preferably they are both substantially white in colour. It is preferred that they are substantially the same in colour as this gives improved differentiation and improves further the perceptibility of the printed image. In another preferred embodiment of the present invention the printed image is luminescent or fluorescent. In another preferred embodiment the image printed on the film may be in multi-coloured.

In a further preferred embodiment of the present invention the coloured liquid and the printed image are substantially different in colour. In the most preferred embodiments the liquid is coloured, for instance yellow, green, orange, blue, pink, and the printed image is white. This has been found to give the improved contrast between the liquid and the printed image; thereby further improving the perceptibility of the image. In other preferred embodiments the image may be multi-coloured or only some of its colours may be different to those of the liquid. This will depend of the function and or message provided by the image. In another preferred embodiment, the unit dose products are stored in a container at least a portion of which enables the individual unit doses within to be viewed. Preferably, the individual unit dose products within the container comprise the same or different coloured liquids as one another.

In a further preferred embodiment of the present invention the water soluble printed film is a transparent polymer film, preferably a colourless transparent polymer film or combinations thereof. Typically, the polymer film comprises poly(vinyl alcohol).

In a further preferred embodiment of the present invention the image on the printed film indicates the origin of said unit dose product; the manufacturer of the unit dose product; an advertising, sponsorship or affiliation image; a trade mark or brand name; a safety indication; a product use or function indication; a sporting image; a geographical indication; an industry standard; preferred orientation indication; an image linked to a perfume or fragrance; a charity or charitable indication; an indication of seasonal, national, regional or religious celebration, in particular spring, summer, autumn, winter, Christmas or Easter; or any combination thereof. Further examples include random patterns of any type including lines, circles, squares, stars, moons, flowers, animals, snowflakes, leaves, and Easter eggs, amongst other possible designs.

Preferably the colour of the liquid is conceptually linked to the image on the printed film. For instance, a unit dose comprising a yellow liquid may have an image of a lemon printed on the film. In an even more preferred embodiment, the image on the film, the colour of the liquid and a third sensorial indicator, such as a perfume, may all be linked by a common theme or concept. For instance, a yellow liquid and an image of a lemon printed on the film, in combination with a lemon scented perfume. This is particularly preferred in embodiments where the unit dose products are stored in a container through at least a portion of which the unit dose products may be seen and embodiments wherein multiple unit doses products comprising different coloured liquids to one another are stored in the same container. This is particularly beneficial for reinforcing or communicating themes to consumers without the need for the written word.

In further embodiment of the present invention, when multiple unit dose products are stored in a container or containers through at least a portion of which the unit dose products contained therein may be seen, preferably the colour of the liquid and preferably the optional image on the printed film and preferably the optional third sensorial indicator are all linked conceptually to indicia on the portions of the container through which the unit dose products may not be seen through. For example, the colour of the liquid may be yellow, the printed image may be of a lemon, a lemon perfume may be used and the indicia on the outside of the container may include images of lemons and/or a written reference to the lemon or citrus themes. This provides a strong and reinforced message to the consumer about the benefits of using the product.

In further embodiment of the present invention when multiple unit dose products are stored in a container or containers through at least a portion of which the unit dose products within said container may be seen, preferably a plurality different multi-compartment pouches comprising different coloured liquids may be present or having different printed images or combinations thereof.

### Unit Dose Detergent Products

Unit dose detergent products are herein understood to incorporate any detergent product wherein the detergent is provided to the consumer in pre-dosed form. In particular, it includes those in the form of pouches having at least one compartment, preferably one or more compartments; wherein the pouch is typically formed from a water soluble material and wherein the at least one compartment typically comprises detergent. Typically, a compartment is understood to include a portion of a unit dose product which comprises detergent and which is defined by a perimeter of, preferably water-soluble, material, such that the detergent cannot leave the portion so-defined without the perimeter material having first been removed, punctured or otherwise broken or most preferably by its dissolution in water. A multi-compartment unit-dose detergent product is understood to mean a unit-dose detergent product, preferably in the form of a pouch, having more than one compartment; a dual compartment unit-dose detergent product is understood to mean a unit-dose detergent product, preferably in the form of a pouch, having two compartments; and a single compartment unit dose detergent product is understood to mean a unit dose detergent product, preferably in the form of a pouch, having only one compartment. It is also envisaged that in certain embodiments the unit-dose detergent products may have two, three, four, five or more compartments.

When unit-dose detergent product comprises more than one compartment, it is preferable that the compartments are arranged in a superposed relationship. This is particularly the case in the instance of dual compartment unit-dose detergent pouches. Superposed can is meant to include wherein the compartments can be symmetrically arranged one above another, side by side or any other convenient disposition provided that the compartments are superposable in use.

When the unit-dose product is in the form of a multi-compartment unit-dose product the product will typically comprise one or more walls. Typically, these walls will comprise a water-soluble film. The water-soluble film comprises two sides and a definite distance between the first side and the second side, preferably less than 1,250 micrometer, preferably from about 0.75 micrometer to about 1,250 micrometer, preferably from about 10 micrometer to about 250 micrometer, more preferably from about 25 micrometer to about 125 micrometer.

The water-soluble film will define the compartments of the product. It is understood that some of the water-soluble film walls of the compartment may be internal walls and others may be external or outer walls. The outer or external walls will have the contents of a compartment adjacent to one of the film sides and the surrounding atmosphere adjacent to the other film sides. For example, the composition will be located adjacent to the first side of the water-soluble film and the atmosphere will be located adjacent to the second side of the water-soluble film.

The internal walls will have the contents of at least one compartment adjacent to at least one of the film sides and the contents of at least one other compartment adjacent to the second film side. The contents of the compartments may include liquids, gels, solids, powders or gasses. The liquids, gels, pastes, solids and powders may comprise detergents. The gas may be included either deliberately, accidentally, as inevitable result of a manufacturing process or be released from one or more of the contents of one or more of the compartments.

The multi-compartment unit dose products may be made by any means known in the art. Particularly, preferred methods include thermoforming, vacuum forming, injection moulding, extrusion and combinations thereof.

The walls of the unit-dose product and/or compartments thereof will typically comprise a water-soluble film. Preferably, the water-soluble film will be selected from the group consisting of poly(vinyl alcohol) films. Further suitable polymer films are discussed in more detail below.

### Coloured Liquid

The coloured liquid of the present invention may be of any colour. Particularly preferred colours include blue, green, yellow, orange, pink and red. Preferably the coloured liquid will only have only one colour and preferably the colour will be uniform, although in some embodiments the coloured liquid may comprise more than one colour. The term liquid may be understood to include liquids, gels and pastes, and any of the aforementioned having separate phases dispersed therein, preferably including emulsions and sols. Preferably, the coloured liquid is substantially transparent or substantially translucent, although it may also be substantially opaque in some embodiments.

Typically the water content of the coloured liquid will be determined by the solubility of the film from which the walls of the multi-compartment unit-dose detergent product are made. Preferably, when a water-soluble film is used the coloured liquid will preferably be anhydrous or have sufficiently low levels of free-water that the film will not dissolve through the action of the coloured liquid alone. Typically the coloured liquid will comprise less than about 30%, preferably less than about 20%, even more preferably less than 10% by weight thereof water.

The coloured liquid may typically be a coloured liquid detergent. Typically the coloured liquid detergent will comprise a dye and, or a pigment and at least one detergent adjunct. Typically, the dye and/or pigment will be selected depending on the colour that is required.

It will be appreciated that in some instances a combination of dyes may be required to achieve the desired colour. Preferred dyes include FD&C Yellow #5 (Clariant), FD&C Red #33 (Clariant) and Acid Blue 182 (Clariant). Preferable detergent adjuncts include, but are not limited to, builders, chelants, enzymes, bleaches, bleach activators, bleach catalysts, metal protectors, surfactants, glass protectors, soil release polymers, perfumes and anti-scalants and combinations thereof.

The unit-dose detergent product for use herein preferably has a volume of from about 5 to about 200 ml, preferably from about 10 to about 100 ml, more preferably from about 15 to 75 ml. In one embodiment, the longitudinal/transverse aspect ratio in the range from about 2:1 to about 1:8, preferably from about 1:1 to about 1:4. The longitudinal dimension is defined as the maximum height of the unit dose detergent product when the unit dose detergent product is lying on one of the bases which have the maximum footprint with the unit-dose detergent product compartments superposed in a longitudinal direction. i.e. one over another, and under a static load of about 2 Kg. The transverse dimension is defined as the maximum width of the unit dose detergent product in a plane perpendicular to the longitudinal direction under the same conditions. These dimensions are adequate to fit the dispensers of the majority of dishwashers or laundry machines. Although the shape of the unit dose detergent product can vary widely, in order to maximise the available volume, preferred pouches have a base as similar as possible to the footprint of the majority of the dispensers, that is generally rectangular.

### Powder Detergent

Powder detergent is herein understood to typically include any detergent in solid form, particularly including granular, spray-dried, agglomerated and compacted detergent compositions and combinations thereof. Preferably, the powder detergent will comprise at least one detergent adjunct selected from the group consisting of builders, chelants, enzymes, bleaches bleach activators, bleach catalysts, metal protectors, surfactants, glass protectors, soil release polymers, perfumes and anti-scalants and combinations thereof. Preferably the powder is white in colour, but may contained coloured particles making up less then 50 vol % of the powder detergent, preferably between 0.01 vol % and 50 vol % by volume of the unit dose compartment containing the powder detergent.

### Detergent Adjuncts

Unless otherwise specified, the components described hereinbelow can be incorporated either in the powder detergent or coloured liquid.

### Organic Solvent

In certain embodiments the coloured liquid may comprise an organic solvent. The organic solvents should be selected so as to be compatible with the tableware/cookware as well as with the different parts of an automatic dishwashing machine. Furthermore, the solvent system should be effective and safe to use having a volatile organic content above 1 mm Hg (and preferably above 0.1 mm Hg) of less than about 50%, preferably less than about 30%, more preferably less than about 10% by weight of the solvent system. Also they should have very mild pleasant odours. The individual organic solvents used herein generally have a boiling point above about 150° C., flash point above about 100° C. and vapor pressure below about 1 mm Hg, preferably below 0.1 mm Hg at 25° C. and atmospheric pressure.

Solvents that can be used herein include: i) alcohols, such as benzyl alcohol, 1,4-cyclohexanedimethanol, 2-ethyl-1-hexanol, furfuryl alcohol, 1,2-hexanediol and other similar materials; ii) amines, such as alkanolamines (e.g. primary alkanolamines: monoethanolamine, monoisopropanolamine, diethylethanolamine, ethyl diethanolamine; secondary alkanolamines: diethanolamine, diisopropanolamine, 2-(methylamino)ethanol; ternary alkanolamines: triethanolamine, triisopropanolamine); alkylamines (e.g. primary alkylamines: monomethylamine, monoethylamine, monopropylamine, monobutylamine, monopentylamine, cyclohexylamine), secondary alkylamines: (dimethylamine), alkylene amines (primary alkylene amines: ethylenediamine, propylenediamine) and other similar materials; iii) esters, such as ethyl lactate, methyl ester, ethyl acetoacetate, ethylene glycol monobutyl ether acetate, diethylene glycol monoethyl ether acetate, diethylene glycol monobutyl ether acetate and other similar materials; iv) glycol ethers, such as ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol butyl ether and other similar materials; v) glycols, such as propylene glycol, diethylene glycol, hexylene glycol (2-methyl-2,4 pentanediol), triethylene glycol, composition and dipropylene glycol and other similar materials; and mixtures thereof.

### Surfactant

In the methods of the present invention for use in automatic dishwashing the detergent surfactant is preferably low foaming by itself or in combination with other components (i.e. suds suppressers). Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, preferably C₁₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants and mixtures thereof including nonionic alkoxylated surfactants (especially ethoxylates derived from C₆-C₁₈ primary alcohols), ethoxylated-propoxylated alcohols (e.g., BASF POLY-TERGENT® SLF18), epoxy-capped poly(oxyalkylated) alcohols (e.g., BASF POLY-TERGENT® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC by the BASF-Wyanidotte Corp., Wyandotte, Mich.; amphoteric surfactants such as the C₁₂-C₂₀ alkyl amine oxides (preferred amine oxides for use herein include C₁₂ lauryldimethyl amine oxide, C₁₄ and C₁₆ hexadecyl dimethyl amine oxide), and alkyl amphocarboxylic surfactants such as MIRANOL™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, LEP-A-0414 549, WO-A-93/08876 and WO-A-93/08874. Surfactants are typically present at a level of from about 0.2% to about 30% by weight, more preferably from about 0.5% to about 10% by weight, most preferably from about 1% to about 5% by weight of composition. Preferred surfactant for use herein are low foaming and include low cloud point nonionic surfactants and mixtures of higher foaming surfactants with low cloud point nonionic surfactants which act as suds suppresser therefor.

### Builder

Builders suitable for use herein include water-soluble builders such as citrates, carbonates and polyphosphates e.g. sodium tripolyphosphate and sodium tripolyphosplhate hexahydrate, potassium tripolyphosphate and mixed sodium and potassium tripolyphosphate salts; and partially water-soluble or insoluble builders such as crystalline layered silicates (EP-A-0164514 and EP-A-0293640) and aluminosilicates inclusive of Zeolites A, B, P, X, HS and MAP. The builder is typically present at a level of from about 1% to about 80% by weight, preferably from about 10% to about 70% by weight, most preferably from about 20% to about 60% by weight of composition.

Amorphous sodium silicates having an SiO₂:Na₂O ratio of from 1.8 to 3.0, preferably from 1.8 to 2.4, most preferably 2.0 can also be used herein although highly preferred from the viewpoint of long term storage stability are compositions containing less than about 22%, preferably less than about 15% total (amorphous and crystalline) silicate.

### Enzyme

Enzymes suitable herein include bacterial and fungal cellulases such as Carezyme and Celluzyme (Novo Nordisk A/S); peroxidases; lipases such as Amano-P (Amano Pharmaceutical Co.), M1 LIPASE® and LIPOMAX® (Gist-Brocades) and LIPOLASE® and LIPOLASE ULTRA® (Novo); cutinases; proteases such as ESPERASE®, ALCALASE®, DURAZYM® and SAVINASE® (Novo) and MAXATASE®, MAXACAL®, PROPERASE® and MAXAPEM® (Gist-Brocades); α and β amylases such as PURAFECT OX AM® (Genencor) and TERMAMYL®, BAN®, FUNGAMYL®, DURAMYL® and NATALASE® (Novo); pectinases; and mixtures thereof. Enzymes are preferably added herein as prills, granulates, or cogranulates at levels typically in the range from about 0.0001% to about 2% pure enzyme by weight of composition.

### Bleaching Agent

Bleaching agents suitable for use herein include chlorine and oxygen bleaches, especially inorganic perhydrate salts such as sodium perborate mono- and tetrahydrates and sodium percarbonate optionally coated to provide controlled rate of release (see, for example, GB-A-1466799 on sulfate/carbonate coatings), preformed organic peroxyacids and mixtures thereof with organic peroxyacid bleach precursors and/or transition metal-containing bleach catalysts (especially manganese or cobalt). Inorganic perhydrate salts are typically incorporated at levels in the range from about 1% to about 40% by weight, preferably from about 2% to about 30% by weight and more preferably from abut 5% to about 25% by weight of composition. Peroxyacid bleach precursors preferred for use herein include precursors of perbenzoic acid and substituted perbenzoic acid; cationic peroxyacid precursors; peracetic acid precursors such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482 807). Bleach precursors are typically incorporated at levels in the range from about 0.5% to about 25%, preferably from about 1% to about 10% by weight of composition while the preformed organic peroxyacids themselves are typically incorporated at levels in the range from 0.5% to 25% by weight, more preferably from 1% to 10% by weight of composition. Bleach catalysts preferred for use herein include the manganese triazacyclononane and related complexes (U.S. Pat. No. 4,246,612. U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410).

### Low Cloud Point Non-Ionic Surfactants and Suds Suppressers

The suds suppressers suitable for use herein include nonionic surfactants having a low cloud point. “Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” nonionic surfactant is defined as a nonionic surfactant system ingredient having a cloud point of less than 30° C., preferably less than about 20° C., and even more preferably less than about 10° C., and most preferably less than about 7.5° C. Typical low cloud point nonionic surfactants include nonionic alkoxylated surfactants, especially ethoxylates derived from primary alcohol, and polyoxypropylene/polyoxyethylene/polyoxypropylene (PO/EO/PO) reverse block polymers.

Also, such low cloud point nonionic surfactants include, for example, ethoxylated-propoxylated alcohol (e.g., BASF POLY-TERGENT® SLF18) and epoxy-capped poly(oxyalkylated) alcohols (e.g., BASF POLY-TERGENT® SLF18B series of nonionics, as described, for example, in U.S. Pat. No. 5,576,281).

Preferred low cloud point surfactants are the ether-capped poly(oxyalkylated) suds suppressor having the formula;

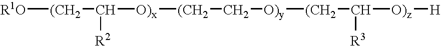

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula;

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

### Other Components

Other suitable components herein include organic polymers having dispersant, anti-redeposition, soil release or other detergency properties invention in levels of from about 0.1% to about 30%, preferably from about 0.5% to about 15%, most preferably from about 1% to about 10% by weight of composition. Preferred anti-redeposition polymers herein include acrylic acid containing polymers such as SOKALAN PA30, PA20, PA15, PA10 and SOKALAN CP10 (BASF GmbH), ACUSOL 45N, 480N, 460N (Rohm and Haas), acrylic acid/maleic acid copolymers such as SOKALAN CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Heavy metal sequestrants and crystal growth inhibitors are suitable for use herein in levels generally from about 0.005% to about 20%, preferably from about 0.1% to about 10%, more preferably from about 0.25% to about 7.5% and most preferably from about 0.5% to about 5% by weight of composition, for example diethylenetriamine penta (methylene phosphonate), ethylenediamine tetra(methylene phosphonate) hexamethylenediamine tetra(methylene phosphonate), ethylene diphosplionate, hydroxy-ethylene-1,1-diphosphonate, nitrilotriacetate, ethylenediaminotetracetate, ethylenediamine-N,N′-disuccinate in their salt and free acid forms.

The compositions herein can contain a corrosion inhibitor such as organic silver coating agents in levels of from about 0.05% to about 10%, preferably from about 0.1% to about 5% by weight of composition (especially paraffins such as WINOG 70 sold by Wintershall, Salzbergen, Germany), nitrogen-containing corrosion inhibitor compounds (for example benzotriazole and benzimadazole—see GB-A-1137741) and Mn(II) compounds, particularly Mn(II) salts of organic ligands in levels of from about 0.005% to about 5%, preferably from about 0.01% to about 1%, more preferably from about 0.02% to about 0.4% by weight of the composition.

Other suitable components herein include water-soluble bismuth compounds such as bismuth acetate and bismuth citrate at levels of from about 0.01% to about 5%, enzyme stabilizers such as calcium ion, boric acid, propylene glycol and chlorine bleach scavengers at levels of from about 0.01% to about 6%, lime soap dispersants (see WO-A-93/08877), suds suppressors (see WO-93/08876 and EP-A-0705324), polymeric dye transfer inhibiting agents, optical brighteners, perfumes, fillers and clay.

Liquid detergent compositions can contain quantities of low molecular weight primary or secondary alcohols such as methanol, ethanol, propanol and isopropanol can be used in the liquid detergent of the present invention. Other suitable carrier solvents used includes glycerol, propylene glycol, ethylene glycol, 1,2-propanediol, sorbitol, dipropylene glycol and mixtures thereof.

### Polymer Film

Preferred materials for the walls of the compartments and/or the printed film are polymeric materials, preferably polymers which are formed into a film or sheet. The polymeric material can, for example, be obtained by casting, blow-moulding, extrusion or blown extrusion of the polymeric material, as known in the art. Preferably, the polymeric material is transparent and/or translucent.

Preferred polymers, copolymers or derivatives thereof suitable for use as material for the walls of the compartments and/or the printed film are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrlamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols (PVA), polyvinyl alcohol copolymers and hydroxypropyl methyl cellulose (HPMC), and combinations thereof. Preferably, the level of polymer in the compartment wall or printed film material, for example a PVA polymer, is at least 60%.

The polymer can have any weight average molecular weight, preferably from about 1000 to 1,000,000, more preferably from about 10,000 to 300,000 yet more preferably from about 20,000 to 150,000.

Mixtures of polymers can also be used as the compartment wall and/or printed film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000.

Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol.

Preferred for use herein are polymers which are from about 60% to about 98% hydrolysed, preferably about 80% to about 90% hydrolysed, to improve the dissolution characteristics of the material.

Most preferred materials are PVA films known under the trade reference MonoSol M8630, as sold by MonoSol LLC of Indiana, US, and PVA films of corresponding solubility and deformability characteristics. Other films suitable for use herein include films known under the trade reference PT film or the K-series of films supplied by Aicello, or VF-HP film supplied by Kuraray.

The compartment wall or printed film material herein can also comprise one or more additive ingredients. For example, it can be beneficial to add plasticisers, for example glycerol, ethylene glycol, diethyleneglycol, propylene glycol, sorbitol and mixtures thereof. Other additives include functional detergent additives to be delivered to the wash water, for example organic polymeric dispersants, etc.

The pouch is made from a water-soluble film, said water-soluble film typically has a solubility of at least 50%, preferably at least 75% or even at least 95%, as measured by the method set out hereinafter using a glass-filter with a maximum pore size of 50 microns, namely:

Gravimetric method for determining water-solubility of the film of the compartment and/or pouch:

10 grams±0.1 gram of material is added in a 400 ml beaker, whereof the weight has been determined, and 245 ml±1 ml of distilled water is added. This is stirred vigorously on magnetic stirrer set at 600 rpm, for 30 minutes. Then, the mixture is filtered through a folded qualitative sintered-glass filter with the pore sizes as defined above (max. 50 micron). The water is dried off from the collected filtrate by any conventional method, and the weight of the remaining polymer is determined (which is the dissolved or dispersed fraction). Then, the % solubility or dispersability can be calculated.

### Printed Film

The printed films used in the present invention will typically comprise one of the above mentioned polymer films having an image printed thereon. The image may preferably be printed on the film either when it is in sheet form, before being used to form the wall or walls of a unit-dose detergent product, or once the unit-dose detergent product has been formed.

Preferred methods for printing on the above-mentioned films include but are not limited to those described in U.S. Pat. No. 5,666,785 and WO 06/124484. Printing is usually done with inks and dyes and used to impart patterns and colours onto a water-soluble film. Any kind of printing can be used, including rotogravure, lithography, flexography, porous and screen printing, inkjet printing, letterpress, tampography and combinations thereof. Preferred for use herein is flexography printing. Flexography printing equipment is relatively cheap and run fast in comparison with other printing techniques. An advantage of flexography is the common multi-printing stations set-up so that multiple printing can be accomplished in one pass with ordinary equipment. Another advantage of flexographic printing is its flexibility to handle printing solutions of high viscosity and wider particle size range than ink jet printing. Flexography is a printing technology which uses flexible raised rubber or photopolymer plates to carry the printing solution to a given substrate. In the process of the invention the flexible plates carry the aqueous solution to the film. The fact that the solution is water based does not give rise to incompatibilities with the plate which can cause the plate to swell thereby impairing in the accuracy of the printing.

Preferably the printed film will form at least one of the outer walls of the multi-compartment unit-dose detergent products; more preferably one of the walls of the compartment comprising a coloured liquid, and most preferably at least one of the outer walls of the compartment comprising a coloured liquid. Preferably the image is printed on the side of the polymer film (the first side) that is in contact with the coloured liquid, and even more preferably on the side of the polymer film in contact with the surrounding atmosphere (the second side). In one particularly preferred embodiment all the walls of the unit-dose liquid detergent product comprise a polymer film printed thereon. In another preferred embodiment all of the outer walls of the unit-dose detergent product comprise printed film. In another preferred embodiment, an internal wall comprises printed film.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A method of improving the visual perceptibility of images on water-soluble printed film for unit dose detergent products comprising printing one or more images on a water soluble film; making a single or multi-compartment from the water soluble printed film; the single or multi-compartment comprising a coloured liquid contained in the single or multi-compartment of the unit dose detergent product, the coloured liquids being located adjacent to the water soluble printed film.

2. A unit dose detergent product comprising a one or more compartments comprising a water-soluble printed film comprising one or more images printed thereon, the one or more compartments containing a coloured liquid such that the one or more images have improved perceptibility.

3. The unit dose detergent product of claim 2 wherein the unit dose detergent product is a multi-compartment pouch.

4. The unit dose detergent product of claim 3 wherein said unit dose detergent product further comprises a powder detergent in a compartment separate from the compartment containing the coloured liquid.

5. The method according to claim 1 wherein said coloured liquid detergent and said printed image are different in colour.

6. The unit dose detergent product of claim 2 wherein the water soluble printed film is a transparent polymer film.

7. A container comprising a plurality of individual multi-compartment unit dose products wherein the individual multi-compartment unit dose products comprise at least one compartment comprising a coloured liquid and a printed water-soluble film having one or more images printed thereon, and wherein at least a portion of the individual multi-compartment unit dose products can be seen through at least a portion of the container or walls thereof; the at least a portion of the container or walls thereof further comprises an indicia corresponding to the one or more images printed on the printed water soluble film.
